(19) United States
(12) Patent Application Publication
(10) Pub. No.: US 2021/0257893 A1
(43) Pub. Date: Aug. 19, 2021

(54) Hybrid Induction Eddy Current Ring Motor with Self Aligning Hybrid Induction/Permanent Magnet Rotor

(71) Applicant: Louis J. Finkle, Lakewood, CA (US)

(72) Inventor: Louis J. Finkle, Lakewood, CA (US)

(21) Appl. No.: 17/307,712

(22) Filed: May 4, 2021

Related U.S. Application Data
(63) Continuation-in-part of application No. 15/438,023, filed on Feb. 21, 2017, now Pat. No. 10,998,802.

(51) Int. Cl. H02K 21/46

(52) U.S. Cl. CPC H02K 21/46

(57) ABSTRACT

A hybrid induction motor includes a fixed stator, an independently rotating first rotor, and a second rotor fixed to a motor shaft. The first rotor is designed to have a low moment of inertia and includes an inductive element which is either an eddy current ring or angularly spaced apart first bars, and also includes permanent magnets on a surface of the first rotor facing the second rotor. The second rotor includes angularly spaced apart second bars. The first rotor is initially accelerated by cooperation of a rotating stator magnetic field with the inductive element. As the first rotor accelerates towards synchronous RPM, a rotating magnetic field of the permanent magnets cooperate with the second bars of the second rotor to accelerate the second rotor. At near synchronous speed the rotating stator magnetic field reaches through the first rotor and into the second rotor coupling the two rotors for efficient permanent magnet operation.

### CROSS-REFERENCE TO RELATED APPLICATIONS

The present application is a Continuation In Part of U.S. patent application Ser. No. 15/438,023 filed Feb. 21, 2017, which application is incorporated in its entirety herein by reference.

### BACKGROUND OF THE INVENTION

The present invention relates to electric motors and in particular to an induction motor having an independently rotating permanent magnet rotor variably coupled to an inductive rotor to reconfigure the motor from asynchronous induction operation at startup to synchronous operation after startup for efficient operation.

A preferred form of electric motors are brushless AC induction motors. The rotors of induction motors include a cage (or squirrel cage resembling a “hamster wheel”) rotating inside a stator. The cage comprises axially running bars angularly spaced apart on the outer perimeter of the rotor. An AC current provided to the stator introduces a rotating stator magnetic field inside the rotor, and the rotating field inductively induces current in the bars. The current induced in the bars creates an induced magnetic field which cooperates with the stator magnetic field to produce torque and thus rotation of the rotor.

The introduction of current into the bars requires that the bars are not moving (or rotating) synchronously with the rotating stator magnetic field because electromagnetic induction requires relative motion (called slipping) between a magnetic field and a conductor in the field. As a result, the rotor must slip with respect to the rotating stator magnetic field to induce current in the bars to produce torque, and the induction motors are therefore called asynchronous motors.

Unfortunately, low power induction motors are not highly efficient at designed operating speed, and are even less efficient under reduced loads because the amount of power consumed by the stator remains constant at such reduced loads.

One approach to improving induction motor efficiency has been to add permanent magnets to the rotor. The motor initially starts in the same manner as a typical induction motor, but as the motor reached its operating speed, the stator magnetic field cooperates with the permanent magnets to enter synchronous operation. Unfortunately, the permanent magnets are limited in size because if the permanent magnets are too large, they prevent the motor from starting. Such size limitation limits the benefit obtained from the addition of the permanent magnets.

U.S. patent application Ser. No. 14/151,333 filed Jan. 9, 2014 filed by the present Applicant discloses an electric motor having an outer stator, an inner rotor including bars, fixed to a motor shaft, and a free spinning outer rotor including permanent magnets and bars, residing between the inner rotor and the stator. At startup, a rotating stator field accelerates the free spinning outer rotor, and after accelerating, the permanent magnets of the free spinning outer rotor accelerate and then lock with the inner rotor to achieve efficient permanent magnet operation.

The design of the '333 application is suitable for some motor designs, but in other designs, surface effects on the surface of the inner rotor reduce coupling of the inner rotor with the rotating magnetic fields.

### BRIEF SUMMARY OF THE INVENTION

The present invention addresses the above and other needs by providing a hybrid induction motor including a fixed stator, an independently rotating permanent magnet first rotor, and a squirrel cage second rotor fixed to a motor shaft. The first rotor is designed to have a low moment of inertia and includes first inductive element(s) comprising either an eddy current ring or angularly spaced apart first bars on a surface of the first rotor facing the stator, and permanent magnets on a surface facing the second rotor. The second rotor includes angularly spaced apart squirrel cage second bars. The first rotor is initially accelerated by cooperation of a rotating stator magnetic field with the first bars. As the first rotor accelerates towards synchronous RPM, a rotating magnetic field of the permanent magnets cooperate with the second bars of the second rotor to accelerate the second rotor. At near synchronous speed the rotating stator magnetic field reaches through the first rotor and into the second rotor magnetically coupling the two rotors for efficient permanent magnet operation.

In accordance with one aspect of the invention, there is provided a hybrid induction motor which includes a fixed stator, an independently rotating Permanent Magnet (PM) first rotor, and a Squirrel Cage (SC) second rotor fixed to a motor shaft. The PM first rotor may include an eddy current ring or a multiplicity of angularly spaced apart first bars, proximal to a surface of the PM first rotor facing the stator, and a plurality of permanent magnets on a surface of the PM first facing the second rotor. The SC second rotor has a multiplicity of angularly spaced apart second bars proximal to a surface of the SC second rotor facing the PM first rotor. The lines of stator magnetic flux pass though the PM first rotor and the SC second rotor at synchronous speed to couple the PM first rotor and the SC second rotor.

The PM first rotor is initially accelerated by cooperation of the rotating stator magnetic field with the first inductive element(s). Once the PM first rotor is rotating, the permanent magnets create a rotating magnetic field in the SC second rotor cooperating with the second bars to accelerate the SC second rotor. As the PM first rotor accelerates towards synchronous RPM, the stator field reaches through the PM first rotor and cooperates with the permanent magnets, and into the SC second rotor coupling the HP and SC rotors, to transition to synchronous operation.

In accordance with yet another aspect of the invention, there is provided a motor having stronger permanent magnets than known Line Start Permanent Magnet (LSPM). Known LSPM motors are limited by braking and pulsating torques caused by the permanent magnets. The first bars and magnets of the PM first rotor are light weight and the HP first rotor is decoupled from the motor shaft and load at startup, allowing stronger permanent magnets than the known LSPM motors. The stronger permanent magnets provide improved efficiency.

In accordance with yet another aspect of the invention, there is provided a motor having first bars of an PM first rotor aligned with second bars of an SC second rotor. At synchronous speed magnetic field lines of the rotating stator magnetic field pass between the aligned bars and into the SC second rotor to magnetically couple the PM first rotor and the SC second rotor.

In accordance with still another aspect of the invention, there is provided a motor having a number of larger squirrel cage bars mixed with smaller squirrel cage bars of the PM first rotor. The larger bars improve the structural strength of the PM first rotor.

In accordance with another aspect of the invention, there is provided a method according to the present invention. The method includes providing electrical current to a stator, generating a rotating stator magnetic field, the rotating stator magnetic field inductively cooperating with a squirrel cage of an PM first rotor, the rotating stator magnetic field accelerating the PM first rotor, permanent magnets of the PM first rotor generating a rotating permanent magnet magnetic field, the rotating permanent magnet magnetic field inductively cooperating with a squirrel cage of the SC second rotor, the rotating stator magnetic field accelerating the PM first rotor, the PM first rotor and SC second rotor approaching synchronous speed, and the PM first rotor and SC second rotor magnetically coupling at synchronous speed.

In accordance with yet another aspect of the invention, there is provided a hybrid induction motor according to the present invention including a Hybrid Permanent Magnet Hysteresis (HPMH) first rotor. An eddy current ring (or hysteresis) inductive starting element replaces the squirrel cage of the PM first rotor to provide initial starting torque. Once the HPMH first rotor reaches synchronous speed, the inductive starting element has no effect on motor operation. The eddy current ring may be any electrically conductive material would be potential material for starting element and is commonly hard chrome or cobalt steel but may be any non ferrous material. A preferably material for the HPMH first rotor ring of the present invention is copper which is efficient because of its high electrical conductivity. Silver is slightly better performing than copper having better electrical conductivity and aluminum is lower performing than copper having less electrical conductivity. Potentially, new nano technology and a new class of highly conductive material could offer better performance than copper.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A shows an end view of an electric motor having an independently rotating Hybrid Permanent (HP) first rotor and a Squirrel Cage (SC) second rotor fixedly coupled to a motor shaft, according to the present invention.

FIG. 1B shows a side view of the electric motor having an independently rotating PM first rotor and a SC second rotor fixedly coupled to a motor shaft, according to the present invention.

FIG. 2 shows a cross-sectional view of the electric motor having the independently rotating PM first rotor and the SC second rotor fixedly coupled to a motor shaft taken along line 2-2 of FIG. 1B, according to the present invention.

FIG. 3 shows a cross-sectional view of the electric motor having the independently rotating PM first rotor and the SC second rotor fixedly coupled to a motor shaft taken along line 3-3 of FIG. 1A, according to the present invention.

FIG. 4 shows a cross-sectional view of a housing and fixed stator portion of the electric motor having the independently rotating PM first rotor and the SC second rotor fixedly coupled to a motor shaft taken along line 2-2 of FIG. 1B, according to the present invention.

FIG. 5 shows a cross-sectional view of the housing and the fixed stator portion of the electric motor having the independently rotating PM first rotor and the SC second rotor fixedly coupled to a motor shaft taken along line 5-5 of FIG. 4, according to the present invention.

FIG. 6 shows a cross-sectional view of the independently rotating PM first rotor of the electric motor having the independently rotating PM first rotor and the SC second rotor fixedly coupled to a motor shaft taken along line 2-2 of FIG. 1B, according to the present invention.

FIG. 7 shows a cross-sectional view of the independently rotating PM first rotor of the electric motor having the independently rotating PM first rotor and the SC second rotor fixedly coupled to a motor shaft taken along line 7-7 of FIG. 6, according to the present invention.

FIG. 8 shows a cross-sectional view of an SC second rotor of the electric motor having the independently rotating PM first rotor and the SC second rotor fixedly coupled to a motor shaft taken along line 2-2 of FIG. 1B, according to the present invention.

FIG. 9 shows a cross-sectional view of the SC second rotor of the electric motor having the independently rotating PM first rotor and the SC second rotor fixedly coupled to a motor shaft taken along line 9-9 of FIG. 8, according to the present invention.

FIG. 10 shows a cross-sectional view of a sixth embodiment of a motor having a PM first rotor according to the present invention.

FIG. 10A shows a cross-sectional view of a stator of the sixth embodiment of the motor having a PM first rotor according to the present invention.

FIG. 10B shows a cross-sectional view of the hybrid inductive/permanent magnet first rotor of the sixth embodiment of the motor having a PM first rotor according to the present invention.

FIG. 10C shows a cross-sectional view of an second inductive rotor of the sixth embodiment of the motor having a PM first rotor according to the present invention.

FIG. 11A shows magnetic field lines of the sixth embodiment of the motor having a PM first rotor at startup according to the present invention.

FIG. 11B shows magnetic field lines of the sixth embodiment of the motor having a PM first rotor at synchronous speed according to the present invention.

FIG. 12A shows magnetic field lines of a two pole embodiment of the sixth embodiment of the motor having a PM first rotor at synchronous speed, excluding the stator according to the present invention.

FIG. 12B shows magnetic field lines of a four pole embodiment of the sixth embodiment of the motor having a PM first rotor at synchronous speed, excluding the stator according to the present invention.

FIG. 12C shows magnetic field lines of a six pole embodiment of the sixth embodiment of the motor having a PM first rotor at synchronous speed, excluding the according to the present invention.

FIG. 12D shows magnetic field lines of an eight pole embodiment of the sixth embodiment of the motor having a PM first rotor at synchronous speed, excluding the stator according to the present invention.

FIG. 13 shows a method according to the present invention.

FIG. 14 shows a cross-sectional view of an embodiment of the present invention including a Hybrid Permanent Magnet Hysteresis (HPMH) first rotor.

FIG. 15A is a cross-sectional side view of the embodiment of the present invention including an HPMH first rotor.

FIG. 15B is an exploded cross-sectional side view of the embodiment of the present invention including an HPMH first rotor.

FIG. 16 is a cross-sectional side view of the HPMH first rotor according to the present invention.

FIG. 17 is a cross-sectional side view of a second SC second rotor according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The term “not mechanically coupled” is used herein to describe a first structure connection to second structure through bearings, and no other mechanical/material connection exists between the first and second structure. The structures may however be magnetically coupled which is not considered a mechanical coupled in the present patent application.

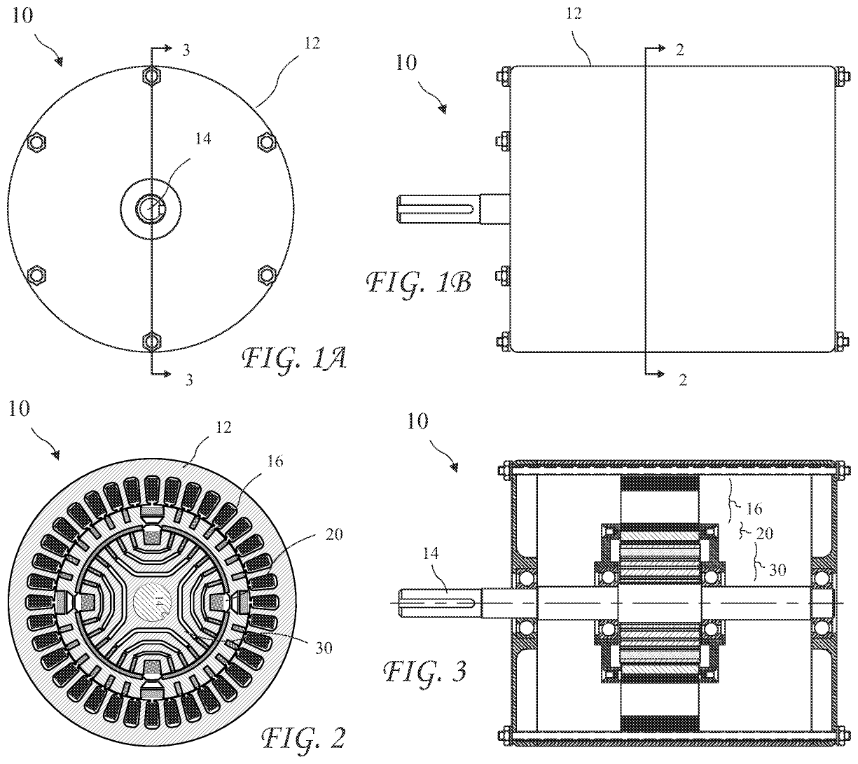

An end view of an electric motor 10 having an independently rotating Permanent Magnet (PM) first rotor 20 and a Squirrel Cage (SC) second rotor 30 fixedly coupled to a motor shaft 14, according to the present invention is shown in FIG. 1A, and a side view of the electric motor 10 is shown in FIG. 1B. A cross-sectional view of the electric motor 10 taken along line 2-2 of FIG. 1B, is shown in FIG. 2 and a cross-sectional view of the electric motor 10 taken along line 3-3 of FIG. 1A is shown in FIG. 3. The electric motor 10 includes a housing 12, a stator portion 16 fixedly coupled to the housing 12, the independently rotating PM first rotor 20 riding on bearings 29 (see FIG. 7), and the SC second rotor 30 fixed to the motor shaft 14. The PM first rotor 20 is mounted to the motor shaft 14 by bearings and is not mechanically coupled to rotate with the motor shaft 14.

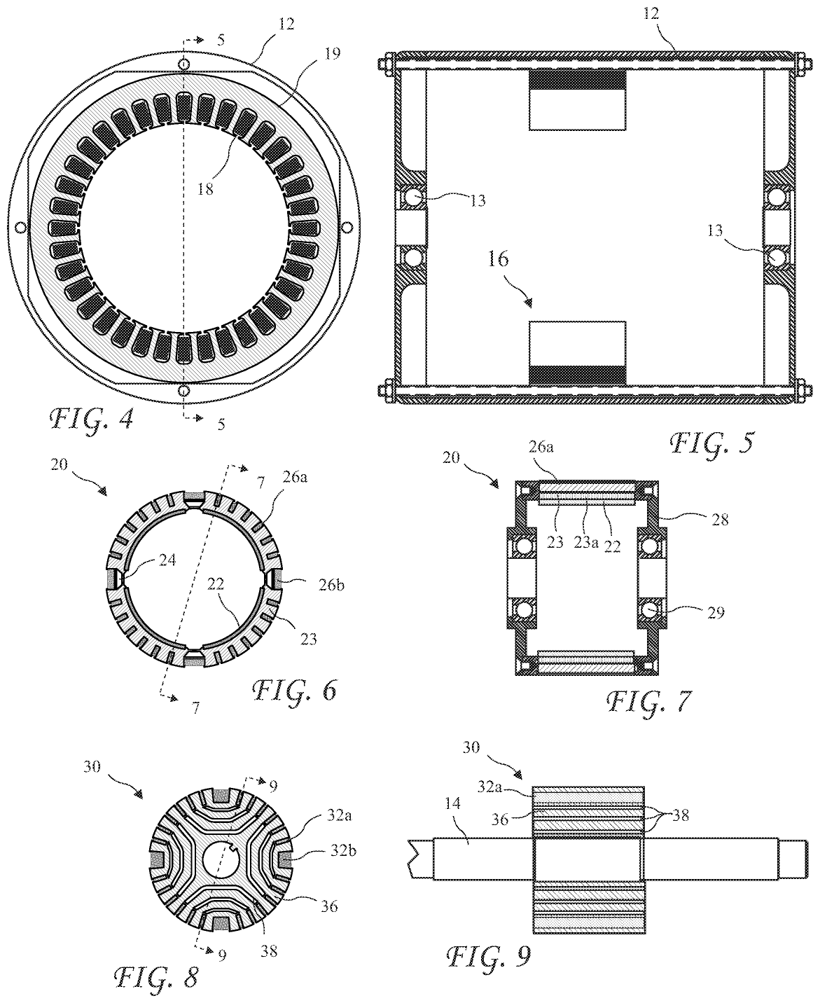

A cross-sectional view of the housing 12 and fixed stator portion 16 of the electric motor 10 taken along line 2-2 of FIG. 1B, is shown in FIG. 4 and a cross-sectional view of the housing 12 and the fixed stator portion 16 taken along line 5-5 of FIG. 4, is shown in FIG. 5. Fixed stator windings 18 reside in a stator core 19. The stator windings 18 create a rotating stator magnetic field when provided with an Alternating Current (AC) signal. The housing 12 includes bearings 13 for carrying the shaft 14.

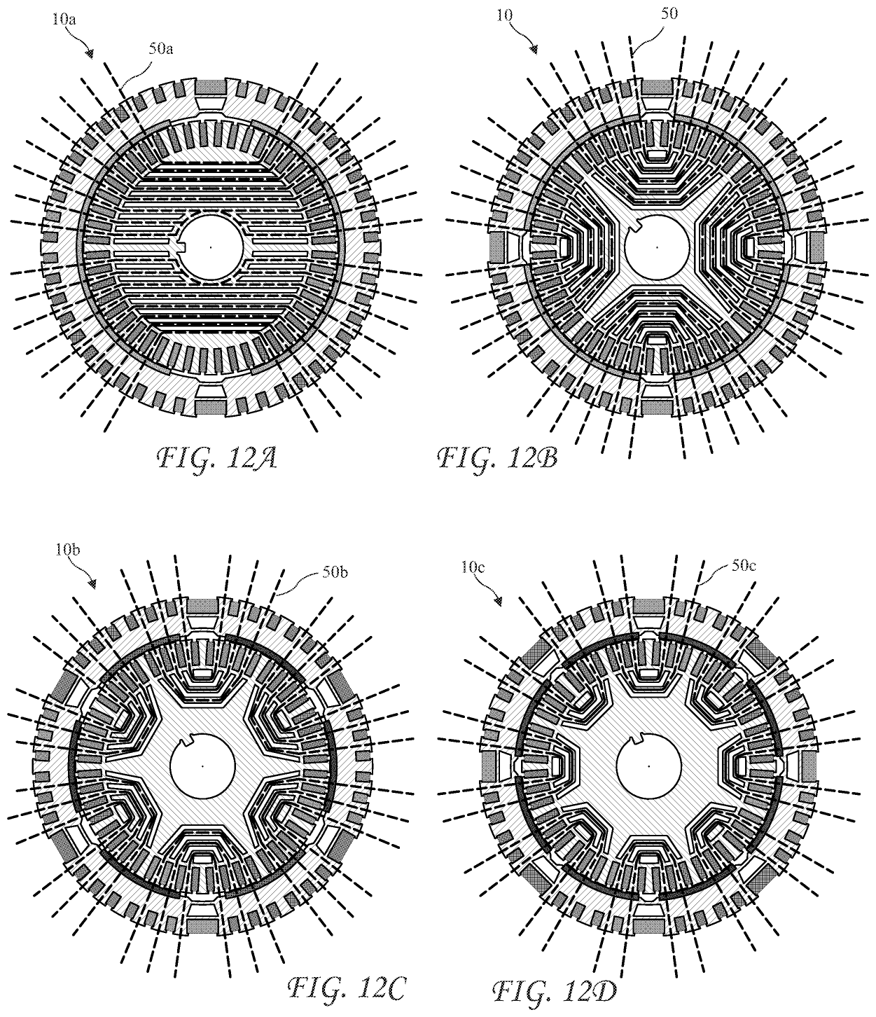

A cross-sectional view of the independently rotating PM first rotor 20 taken along line 2-2 of FIG. 1B, is shown in FIG. 6 and a cross-sectional view of the independently rotating PM first rotor 20 taken along line 7-7 of FIG. 6, is shown in FIG. 7. The PM first rotor 20 includes angularly spaced apart permanent magnets 22 on an interior of the PM first rotor 20 and angularly spaced apart first bars 26a and 26b residing proximal to an outer surface of the PM first rotor 20 embedded in a core (or laminate) 23. The PM first rotor 20 may include any even number of permanent magnets 22, for example, two, four, six, eight, etc. permanent magnets 22 (see FIGS. 12A-12D). Non-ferrous voids 24 may reside in the rotor core 23 between the permanent magnets 22. The voids 24 may be air gaps or non ferrous material to provide flux barriers, if a ferrous material was present between the magnets 22, magnetic flux would curl back into the magnets 22, shorting much of the magnetic flux lines back into the magnets 22. The core 23 is preferably a laminated core and thin laminates 23a of the core 23 forming the core 23 may result in flux leakage. The thickness of the laminates 23a is preferably optimized to minimize the leakage while maintaining mechanical integrity of the rotor core laminates 23. The bars 26a and 26b are preferably evenly angularly spaced apart. The magnets 22 are preferably neodymium magnets bonded to an inside surface of the rotor core 23.

The PM first rotor 20 may include only minor bars 26a but preferably also includes larger major bars 26b providing structural strength. The major bars 26b preferably reside angularly (i.e., may be spaced out radially) between the permanent magnets 22 and the number of major bars 26b preferably us the same as the number of magnets 22. The voids 24 preferably reside under the major bars 26b. The bars 26a and 26b are preferably made of a light weight material, for example, aluminum. The magnets 22 are also preferably made of alight weight material, and are preferably rare earth magnets allowing lighter weight for a given magnet strength. The light weight of the bars 26a and 26, and the magnets 22, reduce the moment of inertia of the PM first rotor 20 allowing the PM first rotor 20 to overcome braking and pulsating torques caused by the permanent magnets 22, thus allowing stronger permanent magnets 22 and greater efficiency than a LSPM motor. A balance between bars 26a and 26b resistance and rotor core 23 saturation may be optimized and the shape, number and dimensions of the bars 26a and 26b may have great effect on performance, for example, motor startup.

Rotor end caps 28 are attached to opposite ends of the PM first rotor 20 and include bearings 29 allowing the PM first rotor 20 to rotate freely on the motor shaft 14. The bearings 29 are preferably low friction bearings (for example, ball bearings or roller bearings), but may simple be bushings (for example, bronze bushings, oilite bushings, or Kevlar® bushings). The PM first rotor 20 is preferably not mechanically coupled to rotate with the SC second 30 or the motor shaft 14 at any time.

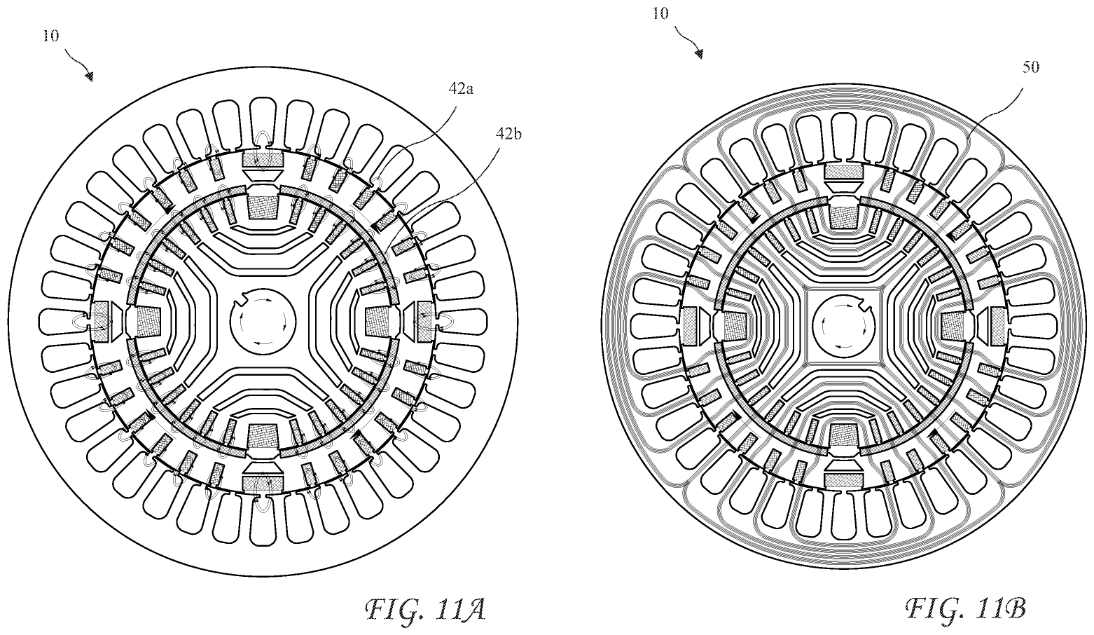

A cross-sectional view of the SC second rotor 30 of the electric motor 10 taken along line 2-2 of FIG. 1B, is shown in FIG. 8 and a cross-sectional view of the SC second rotor 30 of the electric motor 10 taken along line 9-9 of FIG. 8, is shown in FIG. 9. The SC second rotor 30 is fixed to the motor shaft 14 and cooperates with the PM first rotor 20 to magnetically couple the PM first rotor 20 to the motor shaft 14 at synchronous speed. Second minor bars 32a and major bars 32b reside in a second rotor core (or laminate) 36. The bars 32a and 32b are not necessarily, but are preferably evenly angularly spaced apart. The major bars 32b add structural strength to the SC second rotor 30 and help direct lines of magnetic flux 50 (see FIG. 11B).

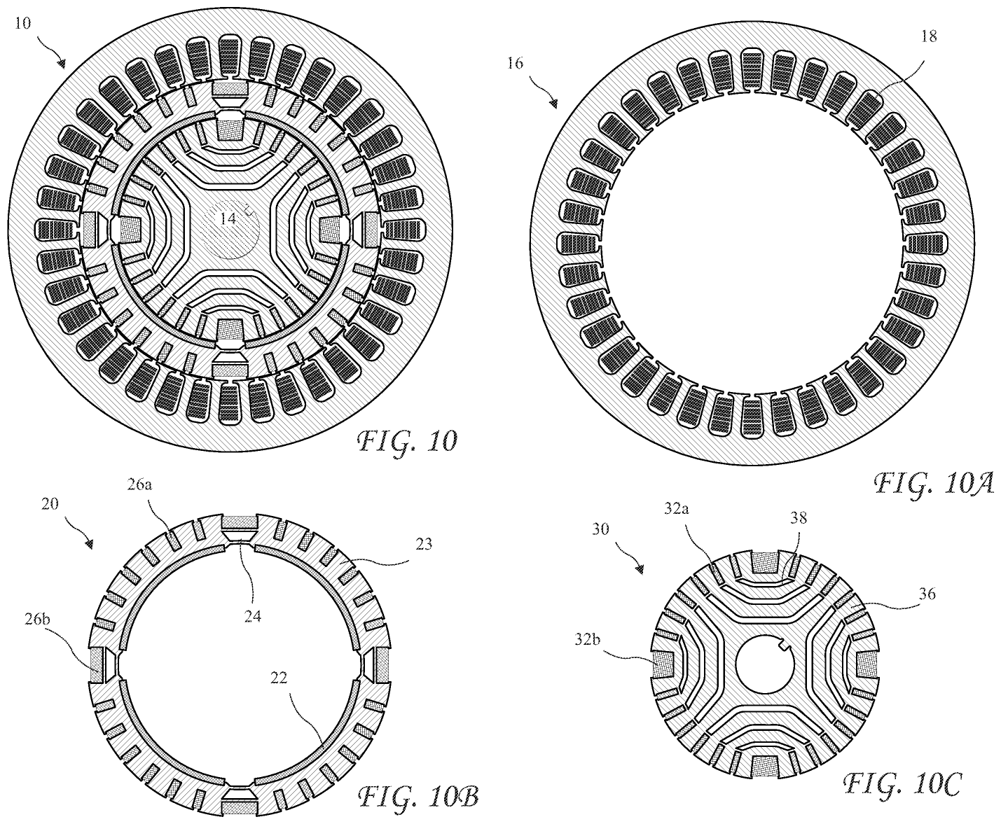

A detailed cross-sectional view of the motor 10 is shown in FIG. 10, a cross-sectional view of a stator 16 of the motor 10 is shown in FIG. 10A, a cross-sectional view of the PM first rotor 20 of the motor 10 is shown in FIG. 10B, and a cross-sectional view of a SC second rotor 30 of the motor 10 is shown in FIG. 10C. The stator 16 includes stator windings 18 in a laminate 19 creating a rotating stator magnetic field.

The PM first rotor 20 is rotationally coupled to the motor shaft through bearings 29 (see FIG. 7) and includes the minor squirrel cage bars 26a and the major squirrel cage bars 26b, the bars 26a and 26b are embedded in the laminate 23. The permanent magnets 24 reside on a surface of the PM first rotor 20 facing the SC second rotor 30.

The SC second rotor 30 includes the minor bars 32a and the major bars 32b. The flux barriers 38 follow a concave path through the laminate 36 and outer ends of the flux barriers 38 are generally aligned with the minor bars 32a. Both the minor bars 32a and the major bars 32b are slightly recessed into the laminate 36.

Magnetic field lines 42a between the stator windings 18 and the bars 26a and 26b at startup and magnetic field lines 42b between the permanent magnets 22 and the bars 32a and 32b of the motor 10 just after at startup are shown in FIG. 11A. The magnetic field lines 42a result from slippage of the bars 26a and 26b with respect to the rotating stator magnetic field. The magnetic field lines 42a are immediately present at startup because the PM first rotor 20 is stationary at startup, and slippage is present between the stationary PM first rotor 20 and the rotating stator magnetic field. The slippage results in current generation in the bars 26 through magnetic induction, and the current produces torque on the PM first rotor 20 to accelerate the PM first rotor 20.

Nearly immediately after startup, as the PM first rotor 20 begins to rotate, slippage is developed between the permanent magnets 22 of the PM first rotor 20 and the bars 32a and 32b of the SC second rotor 30, producing the magnetic field lines 42b. It is an important feature of the motor 10 that the magnetic field lines 42b are not present immediately at startup, because such magnetic field lines rotationally couple the PM first rotor 20 to the SC second rotor, creating resistance to acceleration of the PM first rotor 20. Such resistance may prevent the PM first rotor 20 from overcoming the braking and pulsating torques caused by the permanent magnets in known LSPM motors, and limit the strength of the permanent magnets 22, thus limiting the efficiency of the motor 10. The motor 10 is thus self regulating, only coupling the PM first rotor 20 to the SC second rotor 30 and motor shaft 14, after the PM first rotor 20 has overcome the braking and pulsating torques.

Magnetic field lines 50 between the stator windings 18 and the permanent magnets 22, and further penetrating the SC second rotor 30 of the motor 10 at synchronous speed, are shown in FIG. 11B. At synchronous speed, there is no slippage between the rotating stator magnetic field and the bars 26a, 26b, 32a, and 32b, and therefore no electrical cooperation between the rotating stator magnetic field and the bars 26a, 26b, 32a, and 32b. The rotating stator magnetic field now cooperates fully with the permanent magnets 22, and is guided though the SC second rotor by the flux barriers 38.

Magnetic field lines of a two pole embodiment of the motor 10, excluding the stator 16, are shown in FIG. 12A, magnetic field lines of a four pole embodiment of the motor 10, excluding the stator 16, are shown in FIG. 12B, magnetic field lines of a six pole embodiment of the motor 10, excluding the stator 16, are shown in FIG. 12C, and magnetic field lines of an eight pole embodiment of the motor 10, excluding the stator 16, are shown in FIG. 12D.

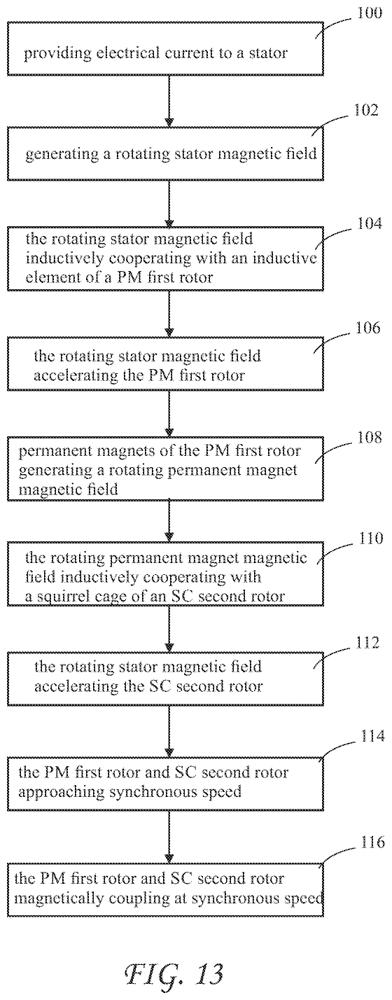

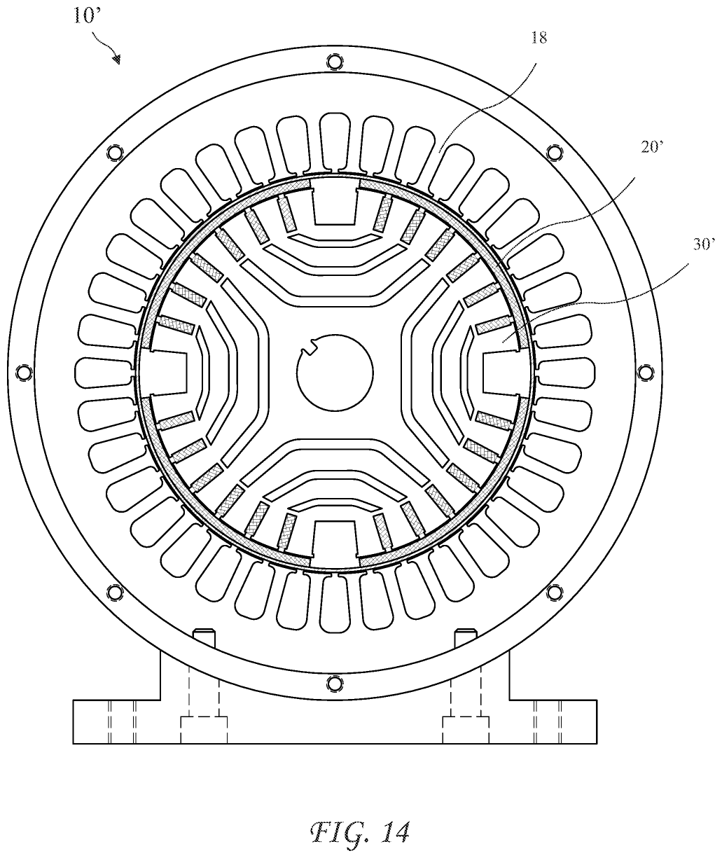

A method according to the present invention is shown in FIG. 13. The method includes providing electrical current to a stator at step 100, generating a rotating stator magnetic field at step 102, the rotating stator magnetic field inductively cooperating with an inductive element(s) of an PM first rotor at step 104, the rotating stator magnetic field accelerating the PM first rotor at step 106, permanent magnets of the PM first rotor generating a rotating permanent magnet magnetic field at step 108, the rotating permanent magnet magnetic field inductively cooperating with a squirrel cage of an SC second rotor at step 110, the rotating stator magnetic field accelerating the PM first rotor at step 112, the PM first rotor and SC second rotor approaching synchronous speed at step 114, and the PM first rotor and SC second rotor magnetically coupling at synchronous speed at step 116. An important feature of the method being that the PM first rotor is not coupled to the SC second rotor until the PM first rotor is rotating, and can thus overcome the braking and pulsating torques which limit permanent magnet strength in LSPM motors.

A cross-sectional view of a second hybrid induction motor 10′ of the present invention including a Hybrid Permanent Magnet Hysteresis (HPMH) first rotor 20′ is shown in FIG. 14. The inductive starting element is an eddy current (or hysteresis) ring 60 (see FIG. 16) which replaces the squirrel cage 26a and 26b of the PM first rotor 20 (see FIG. 6) to provide initial starting torque. The major squirrel cage bars 32b of the SC second rotor are not required and not shown in the hybrid induction motor 10′. The hybrid induction motor 10′ is otherwise similar to the hybrid induction motor 10.

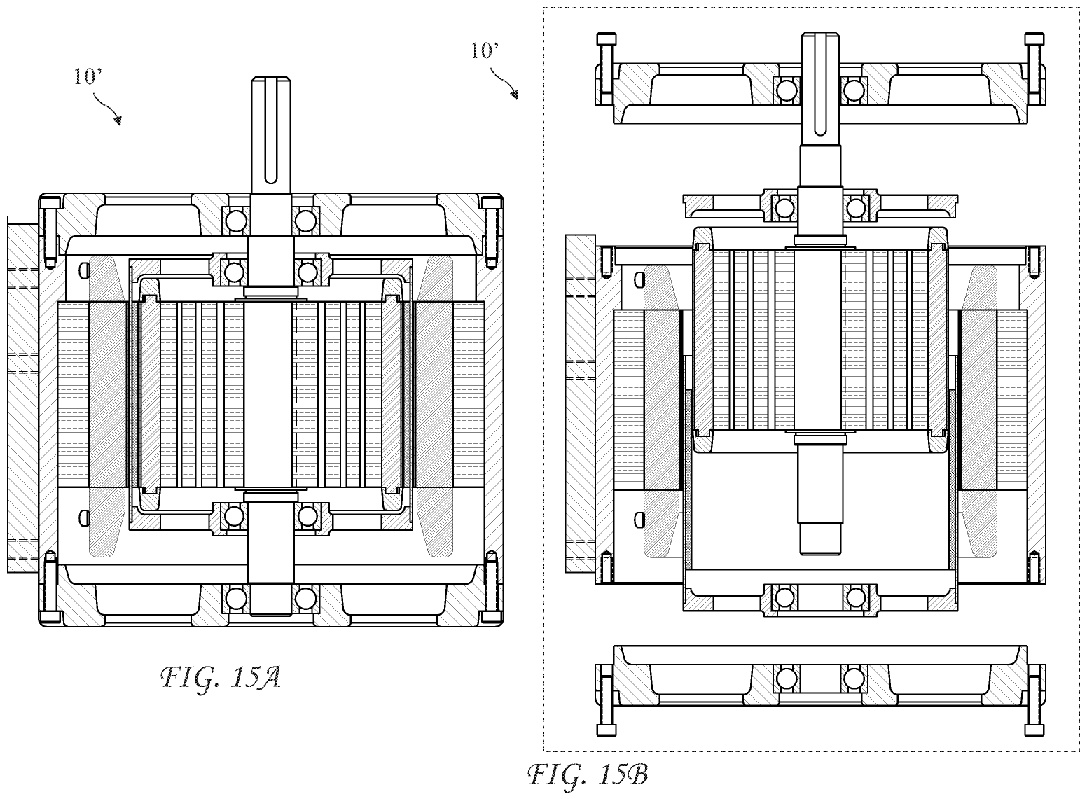

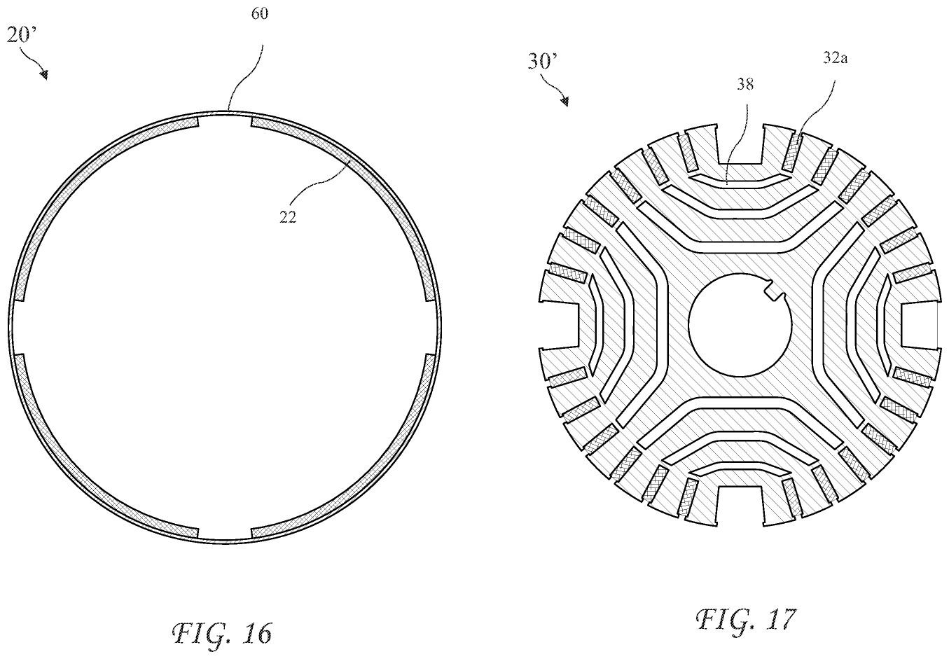

A cross-sectional side view of the hybrid induction motor 10′ including the HPMH first rotor 20′ is shown in FIG. 15A and an exploded cross-sectional side view of the hybrid induction motor 10′ including the HPMH first rotor 20′ is shown in FIG. 15B.

A cross-sectional side view of the HPMH first rotor 20′ showing the eddy current ring 60 is shown in FIG. 16. Once the HPMH first rotor 20′ reaches synchronous speed, the eddy current ring 60 has no effect on motor operation. The eddy current ring 60 may be any electrically conductive material would be potential material for starting element and is commonly hard chrome or cobalt steel but may be any non ferrous material. A preferably material for the HPMH first rotor ring of the present invention is copper which is efficient because of its high electrical conductivity. Silver is slightly better performing than copper having better electrical conductivity and aluminum is lower performing than copper having less electrical conductivity. Potentially, new nano technology and a new class of highly conductive material could offer better performance than copper.

A cross-sectional side view of the second SC second rotor 30′ is shown in FIG. 17. The SC second rotor 30′ does not show the major squirrel cage bars 32b which may be present, but are not necessary. The SC second rotor 30′ is otherwise similar to the SC second rotor 30.

While a magnetically coupled motor is described above having a PM first rotor outside an SC second rotor, and inside-out version of the present invention is also anticipated having a center stator and the SC rotor outside the PM rotor, and those skilled in the art will recognize that such inside-out motor comes within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. A hybrid squirrel cage/permanent magnet motor comprising:
a motor housing;
a stator fixed to the motor housing and producing a rotating stator magnetic field;
a motor shaft rotatably connected to the motor housing and extending from at least one end of the motor housing for attachment to a load;
a second rotor rotationally fixed to the motor shaft residing coaxial with the motor shaft, the first rotor comprising:
a second rotor core;
second electrically conductive squirrel cage bars embedded in the second rotor core; and
a first rotor residing between the stator and the second rotor and coaxial with the motor shaft and not rotationally mechanically coupled to the motor shaft to rotate with the motor shaft, the first rotor comprising:
at least one inductive element on a first surface of the first rotor facing the stator and configured to cooperate with a rotating stator magnetic field to provide torque at startup; and
permanent magnets residing on a second surface of the first rotor facing the second rotor,
wherein the first rotor and the second rotor are magnetically couplable during synchronous operation.

2. The motor of claim 1, further including flux barriers in the second rotor core guiding the rotating stator magnetic field through the second rotor core during synchronous operation.

3. The motor of claim 2 wherein the flux barriers are voids in the second rotor core.

4. The motor of claim 2, wherein the flux barriers are concave paths connecting interior ends of the second electrically conductive squirrel cage bars.

5. The motor of claim 1, wherein:
the first rotor includes a first rotor core; and
the at least one inductive element comprise a multiplicity of angularly spaced apart squirrel cage bars embedded in a surface of the first rotor core facing the stator.

6. The motor of claim 5, wherein the first electrically conductive squirrel cage bars comprise a multiplicity of angularly spaced apart first minor squirrel cage bars separated into equal number groups angularly separated by first major squirrel cage bars, the number of groups and the number of first major squirrel cage bars equal to the number of poles of the motor.

7. The motor of claim 5, wherein the second electrically conductive squirrel cage bars are embedded angularly spaced apart in a second surface of the second rotor core facing the first rotor.

8. The motor of claim 1, wherein the at least one inductive element is an eddy current ring.

9. The motor of claim 8, wherein the eddy current ring is a copper ring.

10. A hybrid squirrel cage/permanent magnet motor comprising:
a motor housing;
a stator fixed to the motor housing and producing a rotating stator magnetic field;
a motor shaft rotatably connected to the motor housing and extending from at least one end of the motor housing for attachment to a load;
a second rotor rotationally fixed to the motor shaft residing coaxial with the motor shaft, the first rotor comprising:
a second rotor core;
second electrically conductive squirrel cage bars embedded in the second rotor core; and
a first rotor residing between the stator and the second rotor and coaxial with the motor shaft and not rotationally mechanically coupled to the motor shaft to rotate with the motor shaft, the first rotor comprising:
an eddy current ring facing the stator and configured to cooperate with a rotating stator magnetic field to provide torque at startup; and
permanent magnets residing on a second surface of the first eddy current ring facing the second rotor,
wherein during synchronous operation, magnetic field lines pass through the permanent magnets, and between the second squirrel cage bars, and the first rotor and the second rotor are magnetically coupled.

11. A hybrid squirrel cage/permanent magnet motor comprising:
a motor housing;
a stator fixed to the motor housing and producing a rotating stator magnetic field;
a motor shaft rotatably connected to the motor housing and extending from at least one end of the motor housing for attachment to a load;
a second rotor rotationally fixed to the motor shaft residing coaxial with the motor shaft, the first rotor comprising:
a second rotor core;
second electrically conductive squirrel cage bars embedded in the second rotor core; and
a first rotor residing between the stator and the second rotor and coaxial with the motor shaft and not rotationally mechanically coupled to the motor shaft to rotate with the motor shaft, the first rotor comprising:
second electrically conductive squirrel cage bars on a first surface of the first rotor facing the stator and configured to cooperate with a rotating stator magnetic field to provide torque at startup; and
permanent magnets residing on a second surface of the first rotor facing the second rotor,
wherein the first rotor and the second rotor are magnetically couplable during synchronous operation.
